(19) United States
(12) Patent Application Publication
(10) Pub. No.: US 2021/0079529 A1
(43) Pub. Date: Mar. 18, 2021

(54) DEVICE FOR ELECTROLESS METALLIZATION OF A TARGET SURFACE OF A LEAST ONE WORKPIECE

(71) Applicant: AP&S INTERNATIONAL GMBH, Donaueschingen (DE)

(72) Inventor: Joerg HILDEBRAND, Donaueschingen (DE)

(21) Appl. No.: 16/970,072

(22) PCT Filed: Jan. 27, 2019
(86) PCT No.: PCT/EP2019/051929

§ 371 Date: Aug. 14, 2020

(30) Foreign Application Priority Data
Feb. 20, 2018 (DE) 10 2018 103 808.9

(51) Int. Cl. C23C 18/16

(52) U.S. Cl. CPC C23C 18/163; C23C 18/1669

(57) ABSTRACT

Arrangement for electroless metallization of a target surface (3) of at least one workpiece (2), comprising—a container (5) for holding a metallization solution (7), —an inlet (8) for the metallization solution (7) arranged in the bottom (6) of the container, —an outlet for the metallization solution (7) arranged on the top of the container (5), —a holder (11) for holding (11) the at least one workpiece (2), wherein the holder is arranged to be movable in at least two dimensions relative to the container (5) by means of a movement device (13).

The present invention relates to a device for electroless metallization of a target surface of at least one workpiece.

Electroless metal deposition from a solution is generally known in the semiconductor industry. Electroless metallization of objects, for example wafers, has clear advantages over galvanic metallization in terms of the durability and the homogeneity and conformity of the layers that can be achieved.

The process of electroless deposition requires an electrolyte solution or a metallization solution with a reducing agent, a metal carrier and an agent forming a complex, wherein—in addition to the control of the bath composition—the pH value and the temperature must also be set with high accuracy, since the active starting of a chemical reaction of the plating solvents by means of a catalyst, which is contained in the underlying material or is applied before the actual deposition process, is extremely sensitive to the process temperature.

Typically, the operating temperature of the electroless metallization solution may be in a range close to the autocatalysis temperature for spontaneous selfdecomposition of the electroless metallization solution. However, the occurrence of self-initiated decomposition of the electroless metallization solution leads to metal deposition not only on desired areas, i.e. the substrate surface to be coated, but also on surfaces of the plating system, such as the reactor cell, the metallization solution tank, the feed lines and the like. In pronounced cases of self-initiated decomposition, substantially the entire metal content of the metallization solution is rapidly reduced to pure metal, which may cause blockage of all lines and tubes and the chemical reactor. As a result, a great deal of effort is required to clean the plating system with nitric acid, and at the same time all of the expensive plating chemicals are lost. In addition, the resulting toxic waste must be disposed of, which also contributes significantly to the operating costs of the electroless metal plating process.

The devices for electroless metallization known from prior art are designed not for use as single wafer systems, but rather for batch processes, in order to increase the throughput that can be achieved. In order to be able to process a plurality of wafers, these are introduced into holders, so-called carriers, a basin in which contains the electrolyte solution. Typically, the wafers are arranged vertically in the carriers, with the electrolyte solution being continuously circulated in the basin in order to ensure a uniform distribution of the reactants within the basin.

Typically, the electrolyte solution is introduced into the basin from below and can be removed from the top and fed to the circulation and heated again. Removal can be implemented, for example, via a simple overflow into an overflow basin.

It is considered a disadvantage with the devices and methods known from prior art that the layer thickness of the deposited metal varies across a wafer and that there are also differences from wafer to wafer within a batch.

It is the object of the present invention to provide a device which enables a more uniform layer deposition.

This object is achieved by a device with the features of claim 1. Advantageous further developments are the subject of dependent claims.

An arrangement according to the invention for the electroless metallization of a target surface of at least one workpiece, comprising a container for holding a metallization solution, an inlet for the metallization solution arranged in the bottom of the container and an outlet for the metallization solution arranged on the top of the container as well as a receptacle for holding the at least one workpiece is characterized in that the receptacle is arranged to be movable in at least two dimensions relative to the container by means of a movement device.

The invention is based on the finding that the coupling of a movement into the reaction process reduces depletion of the metallization solution on its way from the inlet to the outlet and thus a homogeneity and conformity of the metal deposition can be increased. The coupling of a movement into the present process is also referred to as agitation.

Agitation in at least two dimensions improves the transport of the reactants to the target surface of the workpiece.

In a further developed embodiment of the arrangement, the receptacle is arranged to be movable in three dimensions relative to the container, whereby the above-mentioned effects are further improved.

A simple configuration can be achieved if the receptacle is arranged on the movement device via an arm or a frame. A movement of the receptacle by means of the movement device relative to the container is easier to implement than a coupling of movement into the container itself and can also be easily retrofitted for already existing arrangements.

The movement device can, for example, have a base which is fixed relative to the container and on which a first section is mounted via a cross slide and can be driven in two different directions via a first drive. A cross slide, i.e., an arrangement with linear guides standing perpendicular to one another, can execute a two-dimensional movement on a plane spanned by the directions of the linear guides. The first drive can, for example, couple a circular movement into the first section via an eccentric arrangement and transmit it to the receptacle, so that the workpiece arranged in the receptacle executes a movement that equals or corresponds to the coupled movement.

The movement device can also have a second section, which is mounted on the first section by means of a linear guide and can be driven by means of a second drive. The linear guide is preferably perpendicular to the plane defined by the cross slide, so that the second drive causes a movement in the third dimension and can be transferred to the receptacle or the workpiece.

For this purpose, the second drive can be mounted on the first section, so that the movements generated by the first and the second drive are transmitted to the receptacle independently of one another.

The second drive can, for example, cause a linear movement of the second section along the linear guide via an eccentric and a connecting rod.

In order to determine a relative arrangement of the movement device to the container, the base can be firmly connected to an overflow container surrounding the container.

The drives can preferably be controlled independently of one another, so that the differently oriented movements can also be transferred independently of one another to the receptacle.

The drives can be designed, for example, as stepper motors with internal speed control. This type of motor enables a simple and inexpensive construction.

No special ramps or the like are required for the described application, so stepper motors are sufficient. These are simple to operate and no additional sensors are required (e.g. reference or similar).

The receptacles can be designed, for example, as at least one, preferably at least two wafer carriers, so that larger numbers of wafers can be processed in the arrangement.

A particularly simple embodiment of the process can be achieved if it is designed as an overflow.

The frequency of the axis movement must always be set separately for the product in order to guarantee the best possible removal and not to stress the process medium too much. In an exemplary embodiment, a stroke can be 15 mm in each of the first and second directions of movement and 30 mm in the third direction of movement.

The present invention is explained in detail below using an exemplary embodiment example with reference to the accompanying figures. In the drawings:

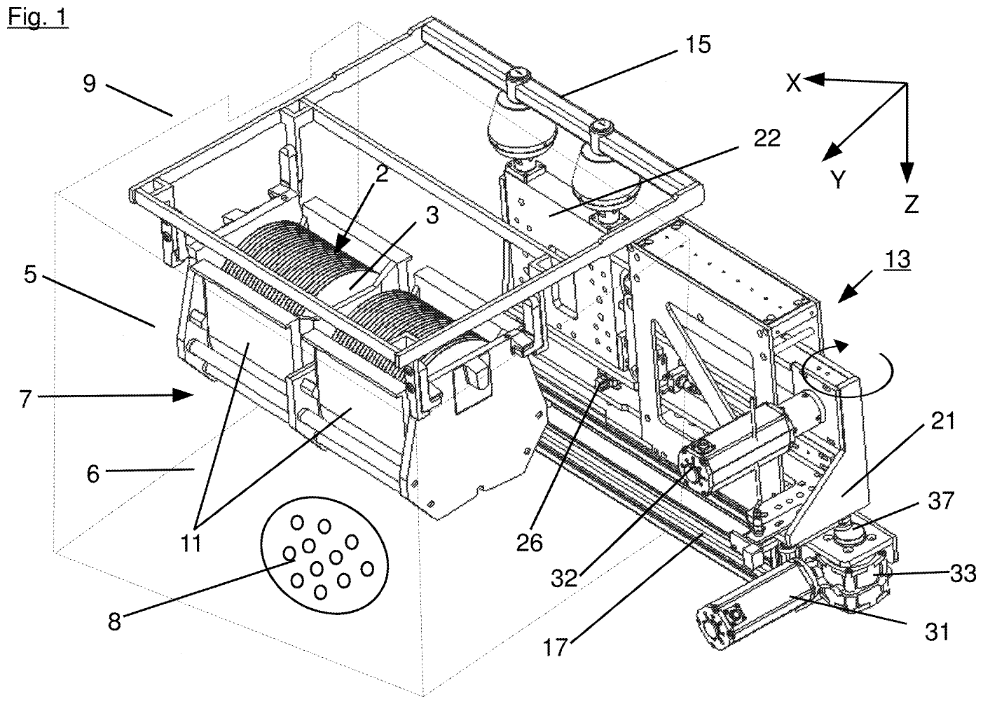

FIG. 1 is a schematic representation of an arrangement according to the present application in perspective view,

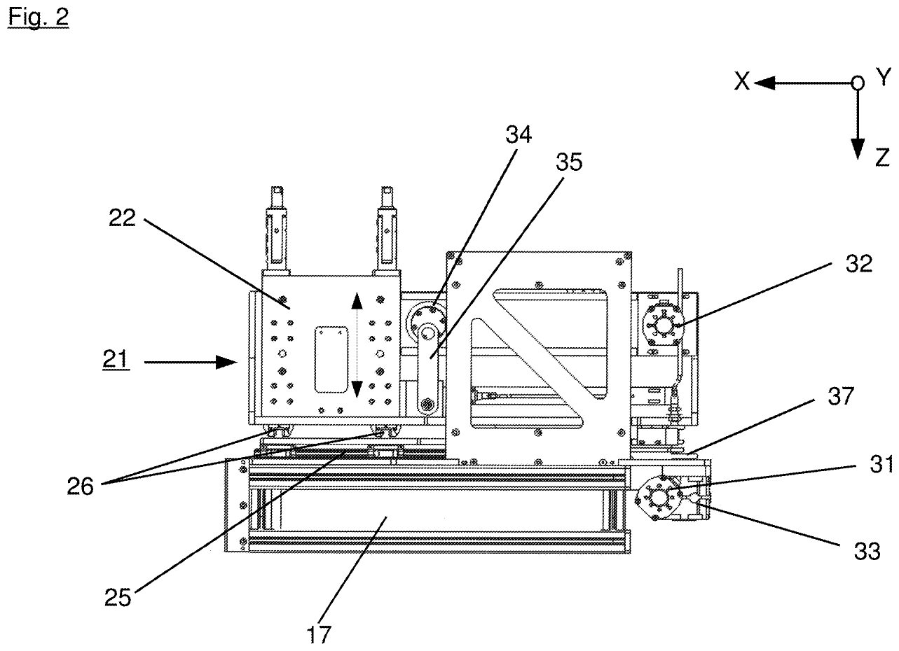

FIG. 2 shows the arrangement of FIG. 1 with the receptacle removed and without a container, and

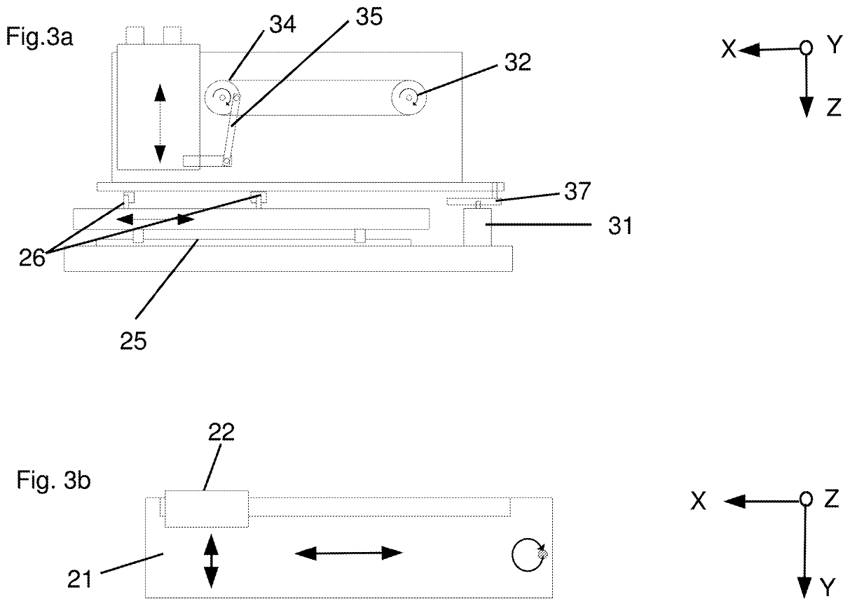

FIG. 3a and FIG. 3b show two schematic sketches to illustrate the coupling of movement.

FIG. 1 shows a perspective illustration of an arrangement for electroless metallization of a target surface of a workpiece according to the present application.

The arrangement substantially consists of a container 5 for holding a metallization solution 7, into which workpieces 2, for example wafers, can be immersed for metallization. In the present embodiment example, a plurality of wafers 2 are arranged vertically in holders 11, which are designed as so-called wafer carriers, and held on a movement device 13 via a frame 15. The holders 11 are arranged on the frame 15 such that the wafers 2 are completely immersed in the metallization solution 7 when the container 5 is full.

The container 5 has an inlet 8 arranged on the bottom and an outlet 9 arranged on the top, which in the present case is designed as an overflow. In order to collect the metallization solution emerging through the overflow 9, the container 5 is arranged in an overflow container which surrounds the container 5. A base 17 of the movement device 13 is fixedly connected to the overflow container, which in the present case is only shown schematically like the container 5 itself.

In the present embodiment example, the movement device 13 is formed from a first section 21 and a second section 22, which are arranged such that they can move relative to the base 17. The first section 21 is arranged such that it can be moved in two directions relative to the base 17 via a cross slide arrangement consisting of first and second guide rails 25, 26 arranged perpendicular to one another. According to the coordinate system shown in FIG. 1 for clarification, the first section 21 can be moved on the X-Y plane.

A movement of the first section 21 is brought about by a first drive 31, which acts on an eccentric 37 via a gear 33. The first section 21 can be moved freely on the X-Y plane via the cross slide arrangement and can thus execute the circular movement coupled in by the eccentric 37 in an identical manner. On the first section 21, a second section 22 is arranged so as to be movable in the Z direction via a linear guide. A linear movement of the second section 22 is transmitted to the second section 22 by a second drive 32, which cooperates with a connecting rod 35 via a belt arrangement with an eccentric 34. A stroke in the X direction and in the Y direction can be 15 mm, for example, and a stroke in the Z direction can be 30 mm, for example.

A transmission of the movements caused by the drives 31, 32 towards the receptacles located in the container 5 takes place via the frame 15 attached to the second section 22.

In FIG. 2, the cross slide arrangement from the first guide rail 25 and the second guide rails 26 can be clearly seen. The first guide rail 25 is oriented in the X direction and the second guide rails 26 are arranged running in the Y direction. FIG. 2 also clearly shows the eccentric 34 of the second drive 32 and the connecting rod 35 connected to it, which cause the second section 22 to move linearly in the Z direction.

The combination of the cross slide arrangement on the one hand and the linear guide on the other hand enables the coupling of a movement in a total of three dimensions, so that a 3D agitation of the workpieces within the metallization bath is achieved.

The movement is mechanically and fixedly determined by the assembled eccentric and the connecting rod. These components specify the range of movement; changing the driving profile is usually not possible without mechanical intervention.

### LIST OF REFERENCE NUMERALS

2 workpiece
3 target surface
5 container
6 bottom
7 metallization solution
8 inlet
9 outlet
11 holder
13 movement device
15 frame
17 base
21 first section
22 second section
25 first guide rail
26 second guide rails
31 first drive
32 second drive
33 gear
34 eccentric
35 connecting rod
37 eccentric

1. An arrangement for electroless metallization of a target surface (3) of at least one workpiece (2), comprising
a container (5) for holding a metallization solution (7)
an inlet (8) for the metallization solution (7) arranged in the bottom (6) of the container,
an outlet for the metallization solution (7) arranged on the top of the container (5),
a holder (11) for holding (11) the at least one workpiece (2),
characterized in that
the holder (11) is arranged to be movable in at least two dimensions relative to the container (5) by means of a movement device (13).

2. The arrangement according to claim 1,
characterized in that the holder (11) is arranged to be movable in three dimensions relative to the container (5).

3. The arrangement according to claim 1, characterized in that the holder (11) is arranged on the movement device via an arm (?) or a frame (15).

4. The arrangement according to claim 3,
characterized in that the movement device (13) has a base (17) which is fixed rela-tive to the container and on which a first section (21) is mounted via a cross slide and can be driven in two different directions (X, Y) via a first drive (21).

5. The arrangement according to claim 3,
characterized in that the movement device (13) has a second section (22) which is mounted on the first section (21) by means of a linear guide and can be driven by means of a second drive (32).

6. The arrangement according to claim 5,
characterized in that the second drive (32) is mounted on the first section (21).

7. The arrangement according to claim 4, characterized in that the second drive (32) has an eccentric (37) and a connecting rod (35) and causes a linear movement of the second section along the linear guide.

8. The arrangement according to claim 4, characterized in that the base (17) is connected to an overflow container surround-ing the container (5).

9. The arrangement according to claim 5, characterized in that the drives (31, 32) can be controlled independently of one another.

10. The arrangement according to claim 5, characterized in that the drives (31, 32) are designed as stepper motors.

11. The arrangement according to claim 1, characterized in that the holder (11) is designed as at least one, preferably at least two wafer carriers.

12. The arrangement according to claim 1, characterized in that the outlet (9) is designed as an overflow.

13. The arrangement according to claim 5, characterized in that a stroke of the second drive is between 20 mm and 40 mm, preferably 30 mm.

14. The arrangement according to claim 4, characterized in that a stroke of the first drive in each of the two directions is between 10 mm and 30 mm, preferably between 12 mm and 18 mm, more preferably 15 mm.
